(19) United States
(12) Patent Application Publication
(10) Pub. No.: US 2014/0006914 A1
(43) Pub. Date: Jan. 2, 2014

(54) SYSTEMS AND METHODS FOR COLLABORATIVE AND MULTIMEDIA-ENRICHED READING, TEACHING AND LEARNING

(71) Applicant: University of Notre Dame du Lac, Notre Dame, IN (US)

(72) Inventors: Elliott Visconsi, South Bend, IN (US); Charles Vardeman, South Bend, IN (US); Kristina Davis, Niles, MI (US); Katherine Anandi Rowe, Bala Cynwyd, PA (US)

(73) Assignee: University of Notre Dame du Lac, Notre Dame, IN (US)

(21) Appl. No.: 13/709,994

(22) Filed: Dec. 10, 2012

Related U.S. Application Data
(60) Provisional application No. 61/630,342, filed on Dec. 10, 2011.

(51) Int. Cl. G06F 17/21

(52) U.S. Cl. CPC G06F 17/211
USPC 715/202

(57) ABSTRACT

The disclosed systems and methods allow a user to view a primary text through the lens of enhanced multimedia features, which allows users to (i) read one or more primary texts; (ii) view textual, audio- and video-based content related to the primary text, (iii) create original textual, video, or audio user-made content, (iv) create personalized views or multimedia documents using the primary text, and supplemental text, audio, and video material, and (v) collaborate, communicate and share user-created content with other users.

### CROSS REFERENCE TO RELATED APPLICATION

This application is a non-provisional application claiming priority from U.S. Provisional Application Ser. No. 61/630,342 entitled “Aereus Superbook Software Framework: A Software platform designed to create a socially collaborative, multimedia innovative electronic reading, teaching, and learning experience.” filed on Dec. 10, 2011, and incorporated herein by reference in its entirety.

### FIELD OF THE DISCLOSURE

The present description relates generally to systems and methods for providing an integrated framework for collaborative and multimedia-enriched reading, teaching and learning.

### BACKGROUND OF RELATED ART

Even as electronic books and electronic reading devices have become increasingly popular, the technology and functionally has not progressed far beyond their paper-based counterparts. Although some attempts have been made to incorporate added functionality to electronic text and electronic books, current technology still does not typically take advantage of the many unique features that electronic media affords. In just one example, electronic reading device platforms are commonly stand-alone programs that provide text display, and text searching capabilities, but little more. In contrast, personal computing devices and web-based devices have developed highly evolved means for interaction, communication, collaboration, and instruction outside of the known electronic book applications. Added functionality has the potential to enrich the reading and learning experience, illuminating added dimensions and nuances to the primary text.

Recently, some attempts have been made to add enhanced features to the electronic reading device platforms. For example, U.S. application Ser. No. 13/171,130, titled “Electronic Book Interface Systems and Methods”, discloses an electronic book system that allows users to make annotations in the book via text, video or audio entries. Users may collaboratively share those annotations with other users and/or compile those annotations to create a study guide. Additionally U.S. Pat. No. 7,401,286, titled “Electronic Book Electronic Links,” discloses an electronic book system that links various sections of the electronic book to graphic files, audio files, reference materials, retail websites, and online discussion groups. However, neither of those references disclose creating a multimedia document using both pre-loaded content (including the primary text) and user-created content. In this way the disclosed software platform is not just a reading device, it is a platform for creating, publishing, and sharing multimedia documents. Moreover, while those documents disclose providing audio content, neither of those references disclose providing audio content that interprets and/or dramatizes the displayed primary text.

Thus, while the background systems and methods identified herein generally work for their intended purpose, the subject invention provides improvements thereto, particularly by providing an integrated framework such as, for example a software framework, for collaborative and multimedia-enriched, reading, teaching and learning.

### BRIEF DESCRIPTION OF THE DRAWINGS

For a better understanding of the present disclosure, reference may be had to various examples shown in the attached drawings.

FIG. 1 illustrates in block diagram form components of an example computer network environment suitable for implementing example framework disclosed.

FIGS. 2A and 2B are block diagrams that illustrate example functions available to the users of the framework.

FIG. 3 illustrates an example page of the framework providing access to various features of the framework.

FIG. 4 illustrates another example page of the framework that displays the primary text and provides access to various features of the system.

FIG. 5 illustrates another example page of the framework that displays the primary text and a navigational bar.

FIG. 6 illustrates another example page of the framework that displays the primary text and provides access to supplemental audio materials.

FIG. 7 illustrates an example page of the framework that displays the primary text and a user-created multimedia document.

FIG. 8 illustrates an example page of the framework that displays the primary text and a filtering tool.

FIG. 9 illustrates an example page of the framework that displays the primary text and provides access to supplemental materials related to the primary text provided by experts.

FIG. 10 illustrates an example page of the framework that displays the primary text and provides users the ability to create textual notes.

FIG. 11 illustrates an example page of the framework that displays the audio-based supplemental materials of the system and provides access to additional supplemental materials.

FIG. 12 illustrates an example page of the framework that displays the video-based supplemental materials of the system.

FIG. 13 illustrates an example page of the framework that displays additional supplemental materials of the system.

FIG. 14 illustrates an example page of the framework that display the expert resources available in the system.

FIG. 15 illustrates an example page of the framework that provides access to user groups.

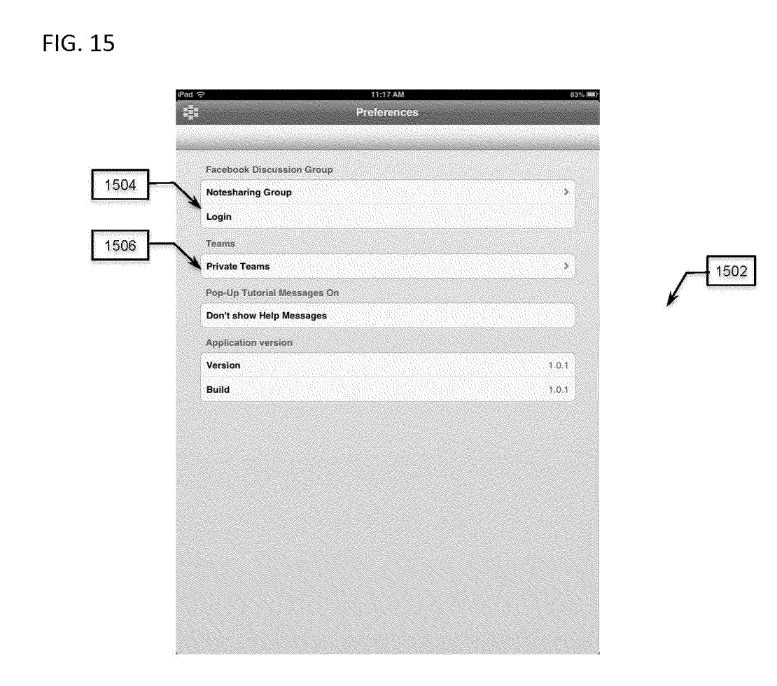

### DETAILED DESCRIPTION

The following description of example methods and apparatus is not intended to limit the scope of the description to the precise form or forms detailed herein. Instead the following description is intended to be illustrative so that others may follow its teachings.

Systems and methods for providing a framework (e.g. software, hardware, firmware, etc.) for collaborative and multimedia-enriched reading, teaching and learning are described herein. The disclosed system may be used in association with any computing device, for example a personal computer, a mainframe computer, a personal-digital assistant (“PDA”), a cellular telephone, a mobile device, a tablet, an e-reader, or the like. The disclosed framework facilitates and enhances a user's experience of a primary text, which may be a book, a play, an essay, a textbook, a reference book or any other appropriate publication. The disclosed framework may be used with one or more primary texts, depending on the user's preferences and the system settings.

The example systems and methods disclosed allow a user to view a primary text through the lens of enhanced multimedia features, to provide users the ability to at least one of (i) read one or more primary texts; (ii) view textual, audio- and video-based content related to the primary text; (iii) create original textual, video, or audio user-made content; (iv) create personalized views or multimedia documents using the primary text, and supplemental text, audio, and video material; and/or (v) collaborate, communicate and share user-created content with other users, which may include peers, instructors, lecturers, members of social networks, classmates, and experts. Of course, it will be appreciated by one of ordinary skill in the art that other features may be provided as desired.

In one aspect of the present disclosure, the framework provides supplemental material that relates to and complements the primary text-this supplemental material may be in the form of text, audio, or video files, and they may be pre-loaded on the software platform, or user-created.

Supplemental textual materials may be, for example, selections or excerpts from the primary text, lecture notes, commentary, analysis, assignments, reports, user notes, user-created commentary, and/or any other appropriate textual content. The textual materials may be pre-loaded onto the framework, or they may be updated in real-time (e.g., through “push notifications”), or available depending on user preferences. For example, a user may choose to “follow” selected users, and receive any textual updates or notes that the selected users publish. Similarly, a group of users may all receive and share textual messages amongst the group, these messages may relate to class assignments (e.g., sent from a teacher to all students, or sent from a student to all other students) a discussion group (e.g., a book club), live internet-based chats, and/or any other appropriate communication means.

Supplemental audio content may include, for example, dramatic interpretations of the primary text, audio commentary, lectures, user-created notations and/or any other appropriate content. For example, the framework may provide a number of alternative dramatic interpretations of the same primary text—listening to these recordings side-by-side gives users a diverse, nuanced interpretation of the primary text. Further, users can create, share, and/or collaborate on audio content—for example, a first user may create and share a first audio recording, while a second user may add to the first audio recording to create a collaborative audio segment.

Supplemental video content may include, for example performances of the primary text, lectures, video commentary, demonstrations, user-created videos, and/or any other appropriate content. Here too users may create, share, and collaborate to create original video content. In one example the primary text is a play, and a user may collaborate with another remote user to perform a rendition of the primary text. Each user may perform a particular role or segment of the primary text and the framework stitches together the two performances to form a single video file.

The supplemental text, video, and audio may be available to the public, or may be restricted to certain users, such as members of a class, students at a certain institution, registered members, etc. Additionally, the framework may utilize certain gamification features including, for example restricting content to only authenticated users, e.g., users who have submitted a requisite number of original content, users who have answered certain questions regarding the primary texts, users who have logged on to a certain social networking site, users who have submitted a requisite amount of user information, and/or any other appropriate authentication criteria.

The disclosed framework also allows a user to create new multimedia documents, and/or customized user views using: (i) the primary text; (ii) pre-loaded supplemental content (in text, audio, and/or video formats); and/or (iii) user-created and shared supplemental content (in text, audio, and/or video formats). For example, a user may highlight or select portions of the primary text and collect the selected text in one or more original multimedia documents. The user may also select portions of the supplemental material (which may be textual, audio, and/or video) to include in a user-created multimedia document. The user may also develop user-created content in the form of textual notes, recorded audio, and/or video clips, and links to other webpages or any other appropriate content. The user may further create a multimedia document which combines one or more of: (i) selections of the primary text; (ii) selected portions of supplemental materials; and (iii) user created content. These multimedia documents may be arranged by user, by subject or theme, by the portion of the primary text that it relates to, by time, and/or any other appropriate organizational structure to create an original document. For instance, the user may select and rearrange portions of the primary text, and supplement it with user-created content to provide an alternative version of the primary text.

In another aspect of the disclosed framework users may share multimedia documents, user-created content, selections of the primary text, the supplemental materials, and/or a user-created multimedia documents with other users via a messaging system, social networking system, email, text messaging, SMS messaging, a wireless network, RF signals, Bluetooth, and/or any other appropriate communication means. Users may also edit and/or republish multimedia documents, allowing multiple users to collaboratively create a final original document. This feature of the framework may be especially advantageous for social networking, group projects, group discussions, class projects, etc.

The framework additionally allows users to communicate with other users, and with user groups. User groups may comprise selected users, e.g., members of a class, members of a book club, members available of a social networking site, members with a shared interest, members of a chat room, members in a certain geographic area, etc. Members of a user group may communicate with each other via a messaging system, social networking system, email, text messaging, SMS messaging, a wireless network, RF signals, Bluetooth, and/or any other appropriate communication means. Members of a user group may share messages (in text, audio, or video). For example, members of a user group may share highlighted or selected portions of the primary text, selected portions of pre-loaded supplemental materials (in text, audio, or video), and/or user-created content (in text, audio, or video). Messages may be used to communicate about the primary text, exchange viewpoints, ask for clarification, submit commentary, collaborate on an original document or assignment, submit assignments, identify people with similar interests, and/or any other appropriate purpose.

In yet another aspect of the framework, users may communicate and collaborate with experts, namely individuals who may have specialized knowledge of the primary text. The experts may be scholars, instructors, professionals, or any other qualified persons. Experts may supply supplemental materials (in text, audio, and/or video formats) related to the primary text, for example, lectures, commentary, analysis, assignments, answers to submitted questions, etc. The framework also provides biographical information related to each expert that users may consider when choosing which expert material to review. Additionally, users may select a “panel” or collection of experts, so that all supplemental materials produced by the selected experts appear in the user's interface, while the material produced to the non-selected experts do not appear. Additionally, the disclosed framework allows users to interact with the experts, for example, users may submit questions (in text, audio, or video format) to selected experts, users may submit responses to expert materials, and users may receive communications from experts. The communications between a user and one or more selected experts may be implemented via a messaging system, social networking system, email, text messaging, SMS messaging, a wireless network, RF signals, Bluetooth, and/or any other appropriate communication means. Moreover, the communications between a user and one or more selected experts may be private (accessible only to the user and the expert); semi-public (accessible to a restricted number of users, e.g., a class; a reading group; a social group the user and all experts; and/or some other appropriate group); or public (available to all users, including all experts).

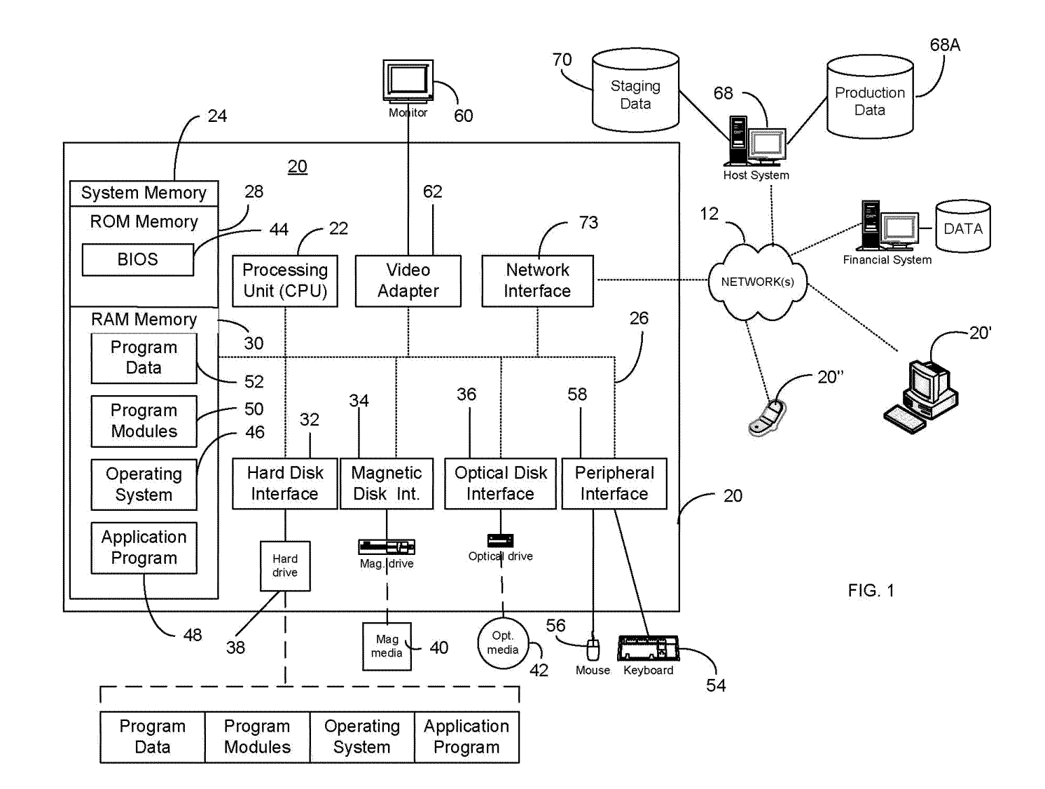

Having described at least some of the features provided by the disclosed framework, with reference to the figures, and more particularly, with reference to FIG. 1, the following discloses various example systems and methods for providing the disclosed framework, such as a personal computer or mobile device. To this end, a processing device 20″, illustrated in the exemplary form of a mobile communication device, a processing device 20′, illustrated in the exemplary form of a computer system, and a processing device 20 illustrated in schematic form, are provided with executable instructions to, for example, provide a means for a user, e.g., a reader, teacher, student, expert, customer, etc., to access a host system server 68 and, among other things, be connected to a hosted framework, which may include downloadable software/firmware components, and/or a database containing user information, e.g., a website, mobile application, etc. Generally, the computer executable instructions reside in program modules which may include routines, programs, objects, components, data structures, etc. that perform particular tasks or implement particular abstract data types. Accordingly, those of ordinary skill in the art will appreciate that the processing devices 20, 20′, 20″ illustrated in FIG. 1 may be embodied in any device having the ability to execute instructions such as, by way of example, a personal computer, a mainframe computer, a personal-digital assistant (“PDA”), a cellular telephone, a mobile device, a tablet, an ereader, or the like. Furthermore, while described and illustrated in the context of a single processing device 20, 20′, 20″ those of ordinary skill in the art will also appreciate that the various tasks described hereinafter may be practiced in a distributed environment having multiple processing devices linked via a local or wide-area network whereby the executable instructions may be associated with and/or executed by one or more of multiple processing devices.

For performing the various tasks in accordance with the executable instructions, the example processing device 20 includes a processing unit 22 and a system memory 24 which may be linked via a bus 26. Without limitation, the bus 26 may be a memory bus, a peripheral bus, and/or a local bus using any of a variety of bus architectures. As needed for any particular purpose, the system memory 24 may include read only memory (ROM) 28 and/or random access memory (RAM) 30. Additional memory devices may also be made accessible to the processing device 20 by means of, for example, a hard disk drive interface 32, a magnetic disk drive interface 34, and/or an optical disk drive interface 36. As will be understood, these devices, which would be linked to the system bus 26, respectively allow for reading from and writing to a hard disk 38, reading from or writing to a removable magnetic disk 40, and for reading from or writing to a removable optical disk 42, such as a CD/DVD ROM or other optical media. The drive interfaces and their associated computer-readable media allow for the nonvolatile storage of computer-readable instructions, data structures, program modules, and other data for the processing device 20. Those of ordinary skill in the art will further appreciate that other types of non-transitory computer-readable media that can store data and/or instructions may be used for this same purpose. Examples of such media devices include, but are not limited to, magnetic cassettes, flash memory cards, digital videodisks, Bernoulli cartridges, random access memories, nano-drives, memory sticks, and other read/write and/or read-only memories.

A number of program modules may be stored in one or more of the memory/media devices. For example, a basic input/output system (BIOS) 44, containing the basic routines that help to transfer information between elements within the processing device 20, such as during start-up, may be stored in ROM 28. Similarly, the RAM 30, hard drive 38, and/or peripheral memory devices may be used to store computer executable instructions comprising an operating system 46, one or more applications programs 48 (such as a mobile application, or web browser), other program modules 50, and/or program data 52. Still further, computer-executable instructions may be downloaded to one or more of the computing devices as needed, for example via a network connection.

To allow a user to enter commands and information into the processing device 20, input devices such as a keyboard 54 and/or a pointing device 56 are provided. While not illustrated, other input devices may include a microphone, a joystick, a game pad, a scanner, a camera, touchpad, touch screen, etc. These and other input devices would typically be connected to the processing unit 22 by means of an interface 58 which, in turn, would be coupled to the bus 26. Input devices may be connected to the processor 22 using interfaces such as, for example, a parallel port, game port, firewire, or a universal serial bus (USB). To view information from the processing device 20, a monitor 60 or other type of display device may also be connected to the bus 26 via an interface, such as a video adapter 62. In addition to the monitor 60, the processing device 20 may also include other peripheral output devices, not shown, such as, for example, speakers, cameras, printers, or other suitable device.

As noted, the processing device 20 may also utilize logical connections to one or more remote processing devices, such as the host system server 68 having associated data repository 68A. The example data repository 68A may include any suitable vendor data including, for example, customer/company information, electronic catalog pages, inventor, etc. In this example, the data repository 68A includes a listing of a plurality of products that are available for purchase. Each of the products includes a vendor item number, and may include an associated secondary item number or description, such as a manufacturer's model number, a keyword description, barcode, etc. In this regard, while the host system server 68 has been illustrated in the exemplary form of a computer, it will be appreciated that the host system server 68 may, like processing device 20, be any type of device having processing capabilities. Again, it will be appreciated that the host system server 68 need not be implemented as a single device but may be implemented in a manner such that the tasks performed by the host system server 68 are distributed amongst a plurality of processing devices/databases located at different geographical locations and linked through a communication network. Additionally, the host system server 68 may have logical connections to other third party systems via a network 12, such as, for example, the Internet, LAN, MAN, WAN, cellular network, cloud network, enterprise network, virtual private network, wired and/or wireless network, or other suitable network, and via such connections, will be associated with data repositories that are associated with such other third party systems. Such third party systems may include, without limitation, websites with video and audio content, course software systems, social networking websites, library systems, retail websites, etc.

For performing tasks as needed, the host system server 68 may include many or all of the elements described above relative to the processing device 20. In addition, the host system server 68 would generally include executable instructions for, among other things, supporting the described framework, including providing access to the primary text, providing access to the supplemental materials, allowing users to create their own supplemental materials, and allowing users to create multimedia documents.

Communications between the processing device 20 and the host system server 68 may be exchanged via a further processing device, such as a network router (not shown), that is responsible for network routing. Communications with the network router may be performed via a network interface component 73. Thus, within such a networked environment, e.g., the Internet, World Wide Web, LAN, cloud, or other like type of wired or wireless network, it will be appreciated that program modules depicted relative to the processing device 20, or portions thereof, may be stored in the non-transitory memory storage device(s) of the host system server 68.

As noted above, in the present example, a customer generally interacts with the host system server 68 to download and use the example framework disclosed herein. To facilitate this process, the host system server 68 provides access to the framework including, for example, applications including primary text(s), supplemental materials (in text, audio, or video format), and access to information about other users, including experts that is made conveniently downloadable or accessible on a page, such as a mobile application page, webpage, etc. displayed on the user computing device.

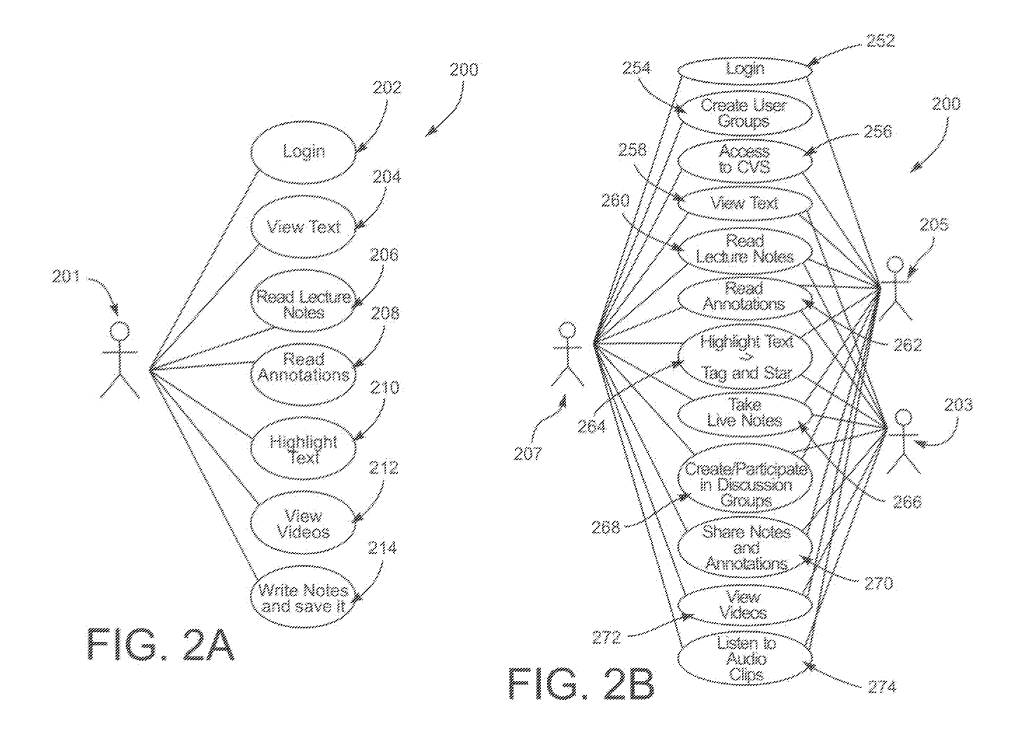

FIGS. 2A and 2B illustrate in block diagram form example functions that are available to the users of an example framework 200. FIG. 2A illustrates various functionalities that are available to the user 201. As will be understood by one of ordinary skill in the art, the functionalities of the various features disclosed herein may be performed in any order, according to the user's preferences. For instance, in a block 202, the user 201 logs in to the framework 200. The login block 202 may provide access to the entire framework 200, or certain functions of the framework 200 (e.g., access to one or more primary texts, access to certain supplemental materials, access to certain user groups, the ability to create and share original content, etc.). The login block 202 may require the user 201 to enter user certain authentication information, such as account information; identification information (e.g., email address, student ID, class password, reading group password, access code, etc.); information about a registered computing device (e.g., a user's mobile device, computer, tablet, etc.); a user's payment information; or any other appropriate authentication means.

As shown in a block 204, the user 201 may view the primary text. As previously discussed, the primary text may comprise a book, a play, an essay, a textbook, a reference book, or any other appropriate publication. In one example, a user may purchase a single primary text or a collection of primary texts. In another example, the framework 200 may provide access to certain primary texts depending on the user's authentication information. Additionally, the primary text may be a multimedia document, consisting of text, illustrations, graphics, audio, and/or video content.

In a block 206, the user 201 may read lecture notes related to the primary text. The lecture notes in block 206 may be from an expert (teacher, lecturer, etc.), and/or from another user. Additionally, the lecture notes in block 206 may be available at the user's 201 request, sent to the user 201 periodically, available for a limited time, and/or sent at the lecturer's request using a “push notification” or similar system. In accordance with the disclosed framework 200, the user 201 may also read annotations or notes related to the primary text. The annotations in a block 208 may be created by either the user 201, by the framework 200, or by another user, such as a lecturer, classmate, expert, etc. Again, these annotations may available at the user's 201 request, updated periodically, available for a limited time and/or sent at the request of the author. Additionally, a user may “follow” certain users and receive notifications whenever the selected users create an annotation 208.

The framework 200 also allows the user 201 to highlight portions of the primary text at a block 210. The highlighting made in the block 210 may be public (available to all users), semi-public (available to certain users), or private (available only to user 201). In a block 212 the user 201 may also view videos related to the primary. The videos in the block 212 may be, for example dramatizations of the primary text, lectures related to the primary text, commentary from experts related to the primary text, documentaries related to the primary text, and/or videos created by other users. Finally, as shown in FIG. 2A, the user 201 may write and save notes in a block 214. In the block 214 the notes may be in text, audio or video format, and the notes may be public, semi-public, or private. For example the notes in the block 214 may be saved to the users account, published on a social networking site, or transmitted to one or more selected users (e.g., a lecturer; an expert, a class user group, a reading group, etc.).

FIG. 2B illustrates another example of the disclosed framework 200, wherein certain features are only available to certain users. For instance, as shown in FIG. 2B, users may fall into various subcategories such as for example, a public user 203, a student user 205, and a lecturer user 207, and/or any other suitable user category. As will be appreciated by one of ordinary skill in the art, the public user 203 may be defined as a user who has not paid a certain subscription fee, has not signed up for a class, has not signed up for a reading group, etc. The student user 205, meanwhile may be a primary school student, a secondary school student, a university student, a student of online class, a member of a reading group, or a member of any other appropriate user group. Finally, the lecturer user 207 may be an instructor (at the primary, secondary or university level), an expert on the primary text, an administrator of a reading group, or any other appropriate individual.

As shown in FIG. 2B, the public user 203 is not required to login at a block 252, and does not have access to certain portions of the data such as, for example data stored on the data repository 68A that is restricted to contain class information at a block 256. However, in this example the public user 203 may view the primary text at a block 258, read lecture notes at a block 260, read annotations at a block 262, highlight and tag the text at a block 264, take notes (in text, audio or video format) at a block 266, create and participate in a discussion group at a block 268, share notes and annotations at a block 270, view videos at a block 272, and listen to audio clips at a block 274. The student user 205 can access all the same functionalities as the public user 203, but in addition, the student user 205 may log in during the authentication process at block 252 and access the restricted class management system at the block 256. The class management system in block 256 may show information about the student user group, including, for example, additional lecture notes, the course syllabus, assignments, grades, attendance, etc. The lecturer user 207 may access all functionalities available to the student user 205, but in addition, the lecturer may create user groups in a block 254. The lecturer user 207 may create user groups in block 254 based on the enrollment in a class, assigned user subgroups, the users' interests, user's geographic location and/or any other appropriate criteria.

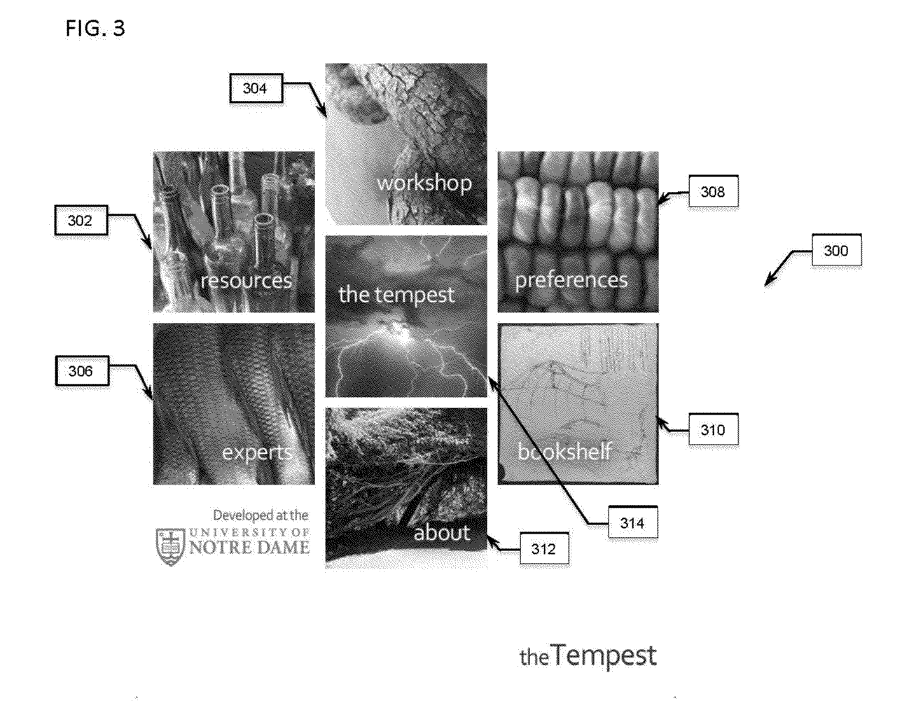

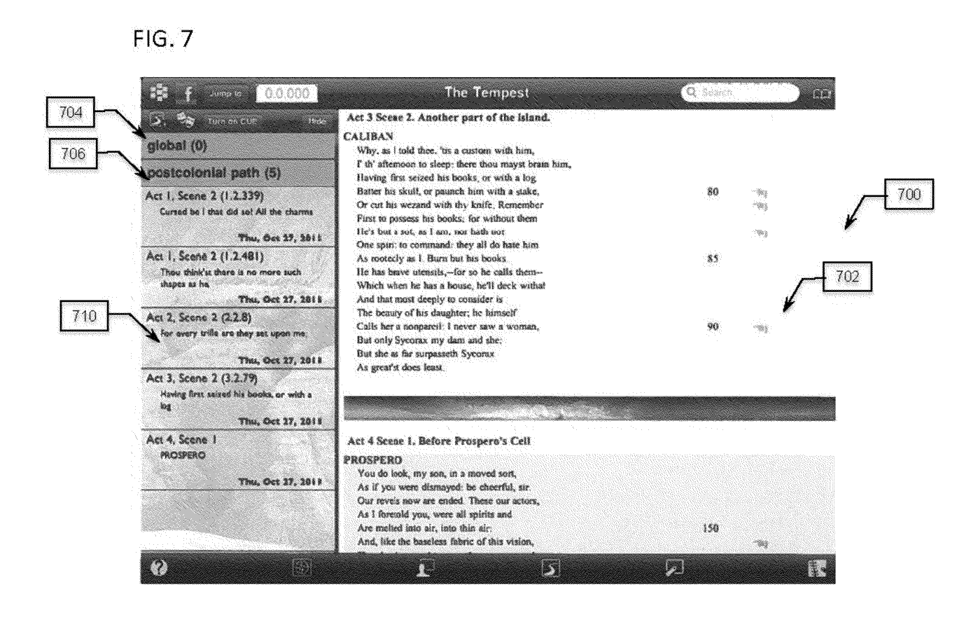

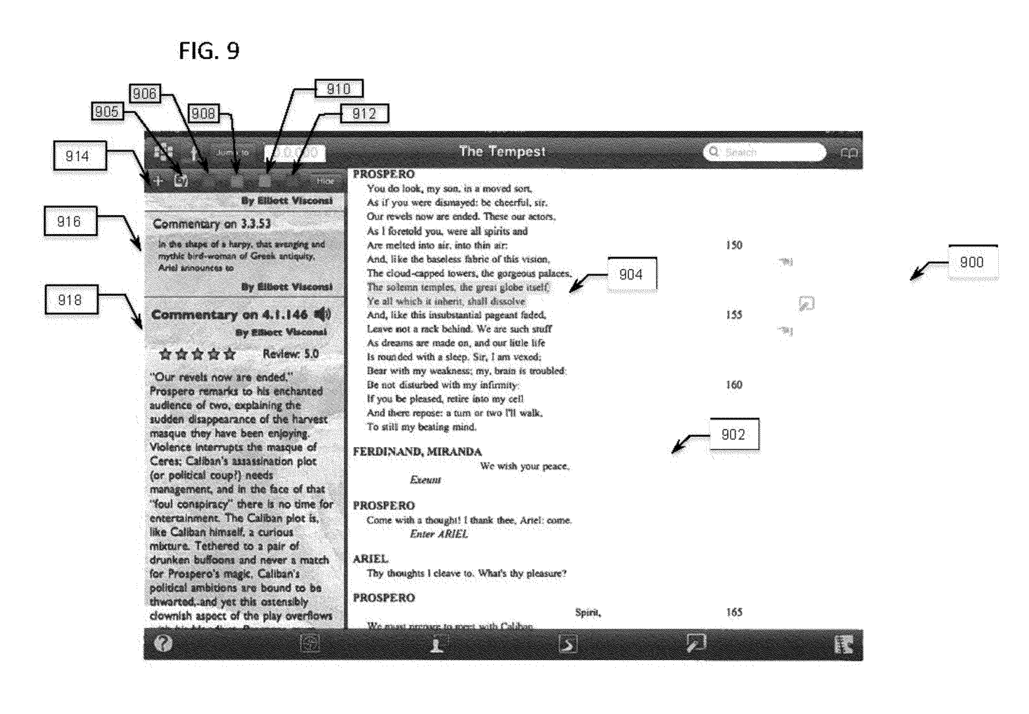

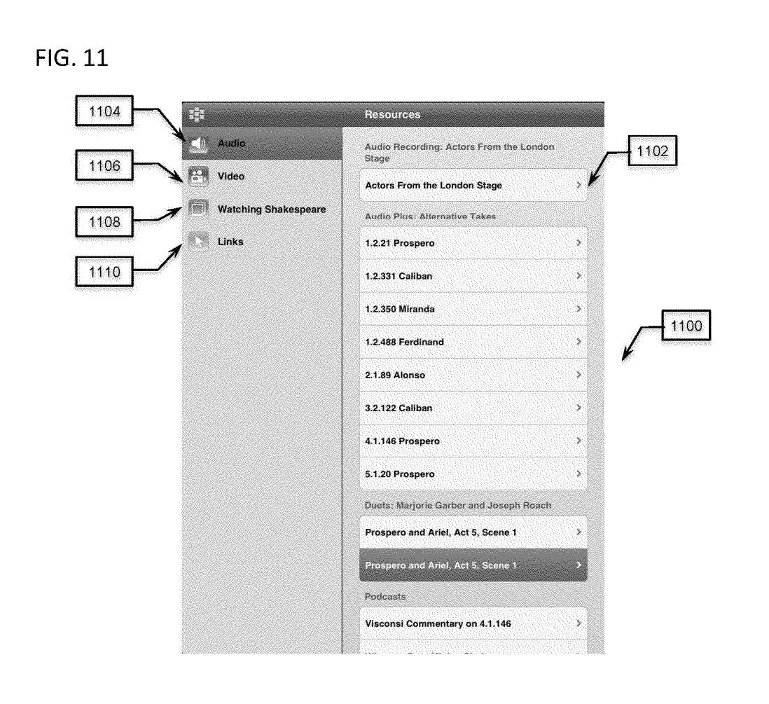

FIG. 3 illustrates an example menu page 300 of the disclosed framework 200 that provides access to various features of the framework 200. As shown in FIG. 3, the framework 200 provides access to the primary text 314, in this example, Shakespeare's “The Tempest.” The framework 200 also provides access to supplemental material 302, labeled “Resources” in this example, which may include audio, video, textual commentary, web links etc. related to the primary text 314, which will be explained in further detail in relation to FIG. 11. The framework 200 also provides access to various experts 306, which may include biographic and background information related to the available experts, means for contacting experts, and means for selecting experts to create an expert panel, which will be explained in further detail with relation to FIG. 9. The framework 200 also provides access to an archive of user-created content 304, titled “Workshop” in this example. The archive 304, which will be explained in further detail in FIGS. 7, 8, and 10, contains multimedia documents containing user-created notes, highlighted passages of the primary text, selections of the supplemental materials, and content received from other users. The about button 312, labeled “About” in this example provides access to additional information about the framework 200. The framework 200 further provides access to user preferences 308, labeled “Preferences” in this example. For example, the user preferences 308 may allow users to join and create user groups, initiate conversations with other users, review and change their accessibility settings, review and modify their privacy settings, etc. Finally, FIG. 3 also illustrates a bookshelf function 310, labeled “Bookshelf” in this example, which provides access to the primary texts and additional materials that are available for the framework 200.

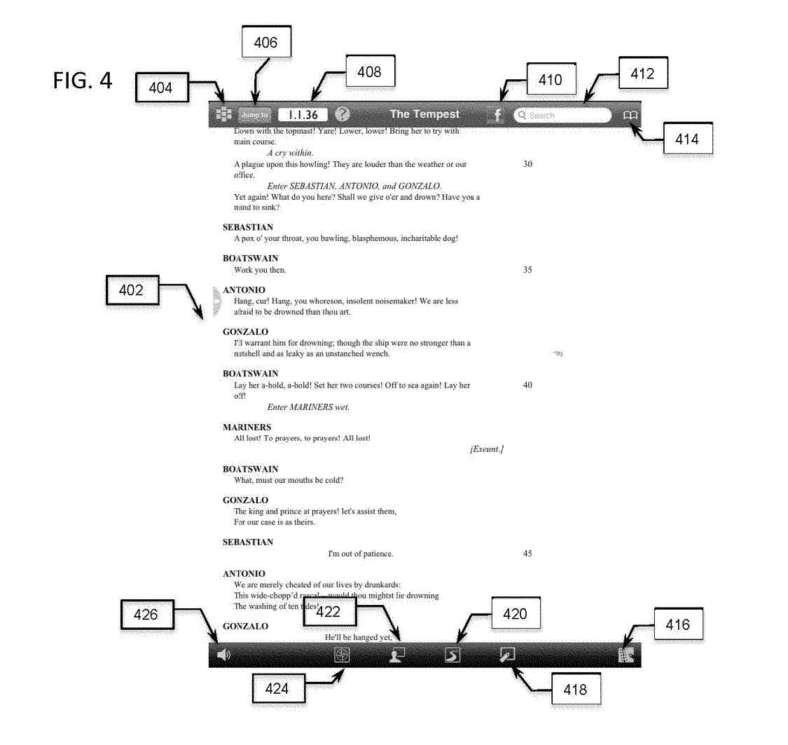

FIG. 4 illustrates an example page 400 of the framework 200 showing a primary text 402 with various functionalities. In this example, the primary text 402 is purely text-based, however, one of ordinary skill in the art will appreciate that the primary text 402 may also include graphics, illustrations and/or demonstratives as desired. A menu button 400 provides access to the example menu page 300 of FIG. 3. A navigation button 406 (e.g. “Jump to”) provides access to the portion of the primary text specified in a navigator textbox 408. In this example, the navigator textbox 408 demarcates the text position in the format “Act: Scene: Line”, however, the navigator textbox 408 may also specify the page number, chapter title, section title, etc. In addition to providing automatic access to a specific portion of the text, the navigator textbox 408 also acts as a line counter, displaying the current position of the primary text 402.

A social networking button 410, allows users to access social networking websites (e.g. Facebook, LinkedIn, class management websites, etc.) to share comments and/or updates regarding the primary text. The disclosed framework 200 also provides a search toolbar 412, which may search the primary text, supplemental materials, and/or user-created content according to system and user preferences. A bookmark button 414 allows users to bookmark a particular section of the primary text by saving the text position, along with quotation(s) from the primary text, and/or user-created notes.

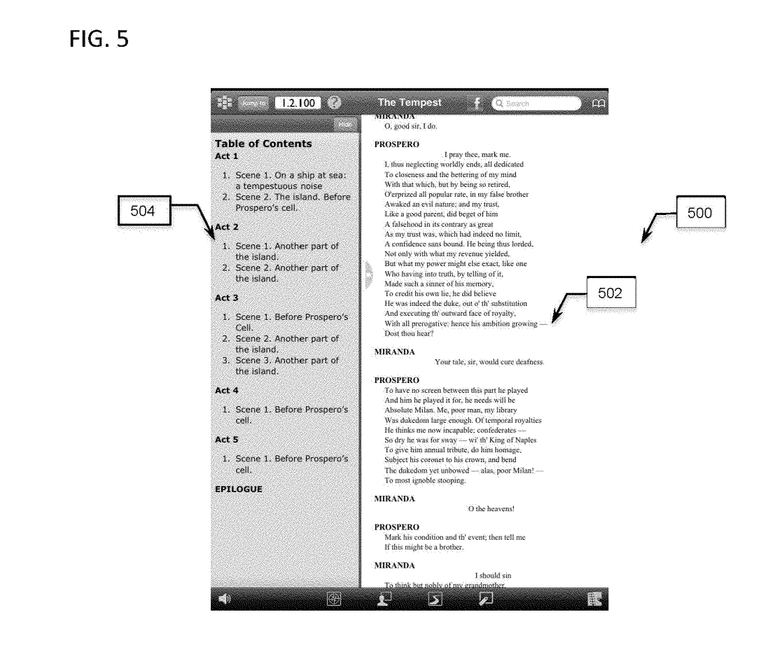

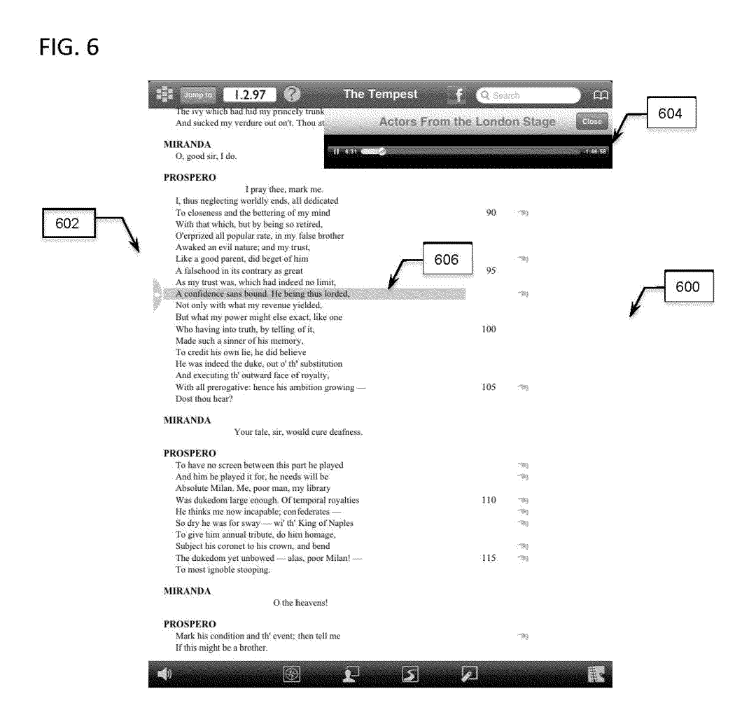

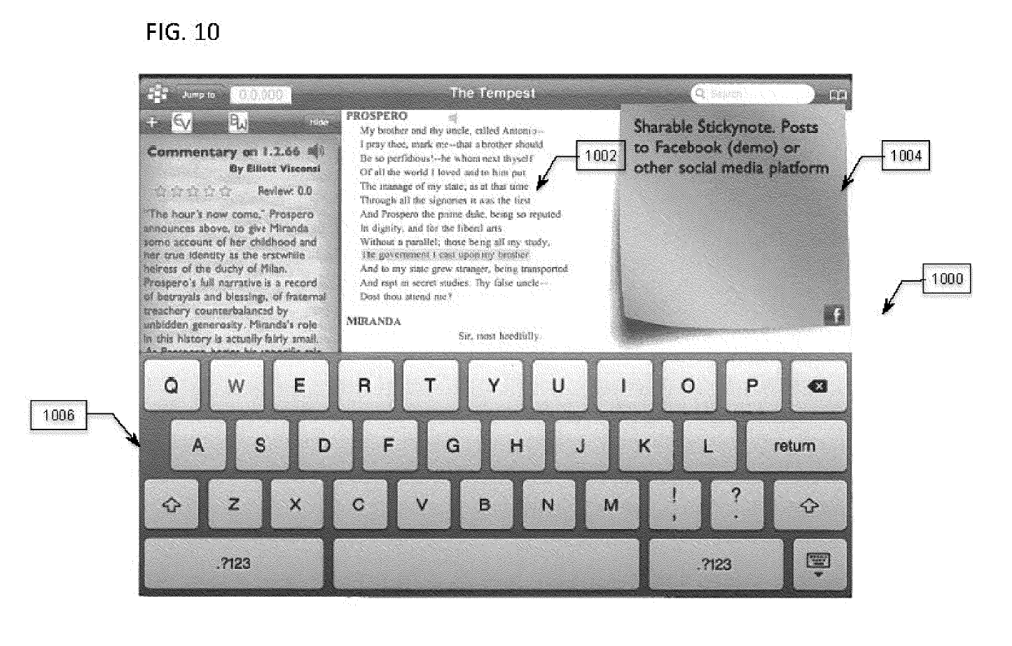

An audio button 426 activates supplemental audio content, which will be explained in further detail in relation to FIG. 6. A table of contents button 424 provides access to the table of contents, as shown in further detail in FIG. 5. An expert button 422 provides access to expert resources, as will be explained in further detail in relation to FIG. 9. The multimedia document button 420 will provide access to the multimedia document editor, which will be explained in further detail in relation to FIG. 7. A new notes button 416 allows users to create notes and the note archive button 418 allows users to access previously created notes—both functions are described in further detail in relation to FIG. 10.

FIG. 5 shows an example page 500 showing a primary text 502 along with a table of contents 504. In the disclosed example, the example page 500 may be accessed through the table of contents button 424 in FIG. 4. In particular, when a user selects the table of contents button 424 in FIG. 4 the framework 200 causes the table of contents 504 to be displayed alongside the primary text 502. In this particular example, the table of contents 504 is organized in acts, and scenes, however as will be appreciated, the table of contents may be in any appropriate format, such as by chapter, subject, user-created notes, and/or any other appropriate structure.

FIG. 6 shows an example page 600 showing a primary text 602 along with an example of an audio material 604. In the disclosed example, the example page 600 may be accessed through the audio button 426 in FIG. 4. In this particular example, the audio material 604 comprises a dramatic interpretation of the primary text from a particular theatre company. As the audio material 604 progresses, the corresponding portion of the primary text 606 is highlighted. Additionally, one of ordinary skill in the art will recognize the audio material 604 may also include, multiple dramatic interpretations of the primary text, expert commentary related to the primary text (e.g., lectures, expert analysis, explanations, question-and-answer recordings etc.) or user-created audio content (e.g., user commentary, user-created dramatization of the primary text, live multi-user conversations regarding the primary text, responses to other user-created audio content etc.). Multiple interpretations of the same primary text, and supplemental audio commentary will enrich the user's experience with primary text by presenting multiple, diverse interpretations of a single text. Further, the framework 200 allows users to listen to alternative audio content side-by-side, encouraging comparative analysis. Additionally, the software platform gives users the ability to create their own dramatizations and commentary related to the primary text (either individually, or in collaboration with additional users). For example, the framework 200 allows one user to record a certain portion of the primary text (e.g., one actor's role), while another user records a complementary portion of primary text (e.g., a second actor's role). In that example, the two recordings may be stitched together to create a complete dramatic interpretation of the text. Thus the framework 200 provides users with the opportunity to create, publish, share, and access original user-created audio content.

FIG. 7 illustrates an example page 700 containing a primary text 702 and a multimedia document editor 704. The example page 700 may be accessed through the multimedia document button 420 in FIG. 4. The framework 200 disclosed herein supports a multimedia document editor 704, which allows users to create various multimedia documents 706 comprising multimedia components 710. The multimedia components 710 may comprise (i) selected portions of the primary text, (ii) selected portions of the supplemental materials (e.g., text, audio, and/or video commentary), (iii) user-created content (text, audio or video), and/or (iv) shared user-created content or collaborations. The multimedia components 710 may be combined and arranged into one of the multimedia documents 706 according to the user's preferences. For example, the multimedia document 706 may be organized by subject matter, by date, by source, by theme and/or any other user preference. In another example, a user may create a “mashable” version of the primary text, by rearranging and manipulating portions of the primary text to create a new text. In another aspect of the disclosure the user may use the multimedia document editor 704 to create customized views of the primary text comprising selected commentary, audio content, video content, expert commentary, and/or social features of the user's choosing. A user may use the multimedia document editor 704 to create, for example, a book report, an outline, a study guide, a personalized reading experience, an original work, and/or any other appropriate document.

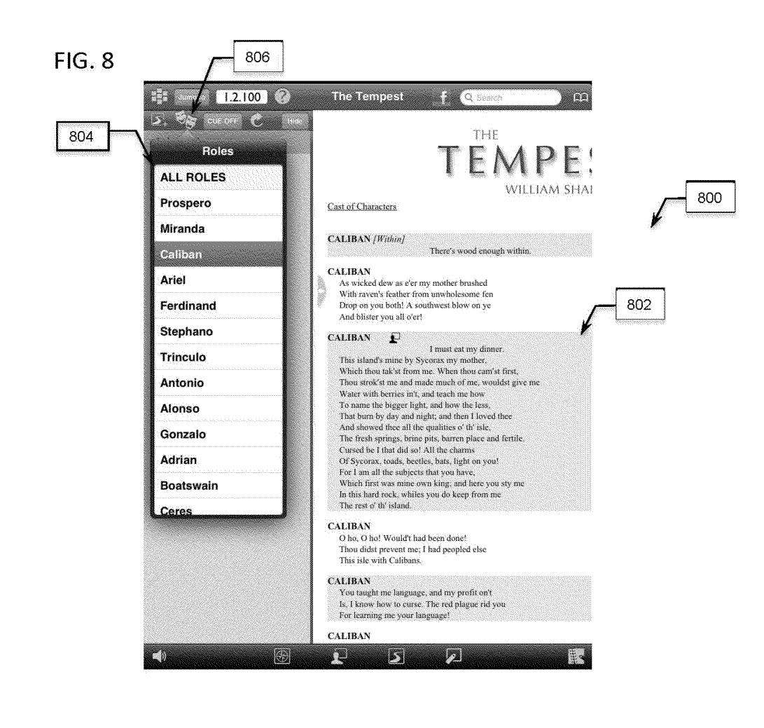

FIG. 8 illustrates an example page 800 of the disclosed framework 200 containing a primary text 802 and a text-filtering tool 806 with filtering criteria 804. In the illustrated example, the filtering criteria 804 is based on the actors in the example primary text. For instance, as will be appreciated, when the “Caliban” filter 804 is selected, the primary text 802 is altered to show the actor Caliban's lines. However, one of ordinary skill in the art will readily appreciate, the filtering criteria may be any appropriate organizational structure, including, for example by subject, time-period, theme, expert-created criteria and/or any user-created criteria.

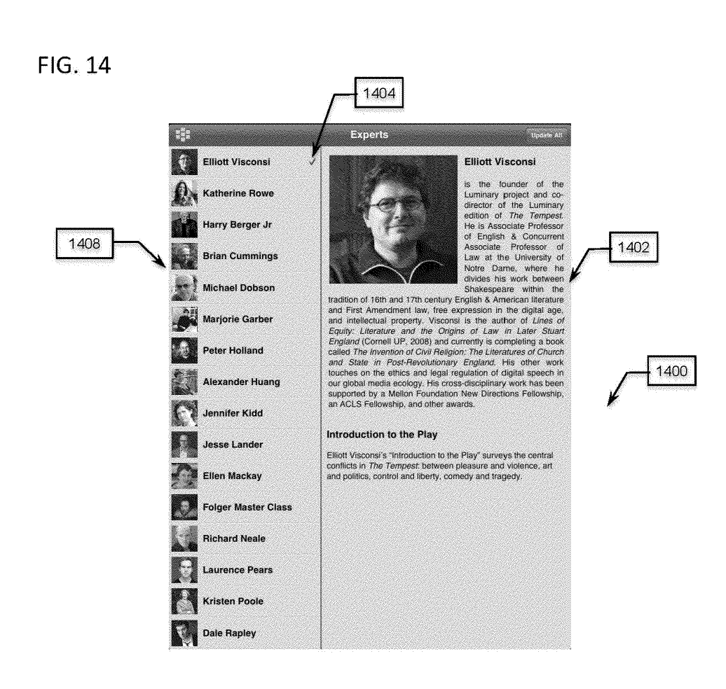

FIG. 9 illustrates an example page 900 of the framework 200 that displays a primary text 902 and provides access to supplemental materials 916, 918 provided by experts e.g., at blocks 905, 906, 908, 910, and 912. As shown in FIG. 9, the expert blocks 905, 906, 908, 910, and 912 each correspond to an individual expert, and collectively those experts make up an expert panel. Users may add additional experts using an add button 914. In accordance with the present disclosure, experts may be instructors, professors, lecturers, framework administrators, students, users, members of a social networking website, and/or any other appropriate individual. (As will be explained in further detail in relation to FIG. 14, the framework 200 may provide background and biographical information for each expert, which may inform a user's choice when assembling the expert panel). When a user selects an expert on the expert panel, e.g., 905, 906, 908, 910, and 912 a supplemental material (text, audio or video) e.g., 916, 918 provided by the selected expert is displayed alongside the corresponding primary text 902. It will be readily understood that the supplemental material may be pre-loaded commentary, or multimedia documents created by users of the framework 200.

In the example page 900, the expert block 905 represents a first expert on the expert panel, who has been selected. Thus, the first expert's supplemental materials 916 and 918 are displayed alongside the primary text. As shown, the supplemental material 918 may include any combination of text, audio and/or video content. Moreover, the framework 200 allows users to rate the supplemental material 916. Additionally, when the user selects a particular supplemental material 918, the framework 200 highlights a corresponding section 904 of the primary text 902. Although only the first expert 905 is selected in this example, it will be readily understood that a user may select multiple experts e.g., 906, 908, 910, and 912, and the supplemental material from each of those experts will be displayed alongside the primary text 902.

FIG. 10 illustrates an example page 1000 that displays a primary text 1002, a user-created note 1004 and a user keyboard 1006. As previously discussed, example page 1000 may be accessed through the new notes button 416 in FIG. 4. Users may enter text via the keyboard 1006, and save those notes 1004 using the multimedia document editor 704, or share them with other users on a class management site, a social media site, a messaging system, email, text messaging, SMS messaging, a wireless network, RF signals, Bluetooth and/or any other appropriate communication means.

As shown in FIG. 11, an example page 1100 shows various audio materials 1102 that are available in the framework 200. (In accordance with one aspect of the disclosure, the example page 1100 may be accessed through the supplemental material button 302 in FIG. 3.) As previously discussed, the audio materials may include dramatic interpretations of the primary text, expert commentary related to the primary text, user-created commentary, user-created interpretations of the primary text, and/or collaborative audio materials created by two or more users. Additionally the example page 1100 provides access to audio materials via a button 1104; video materials via a button 1106; supplemental textual materials via a button 1108; and links to webpages and materials outside the framework 200 via a button 1110.

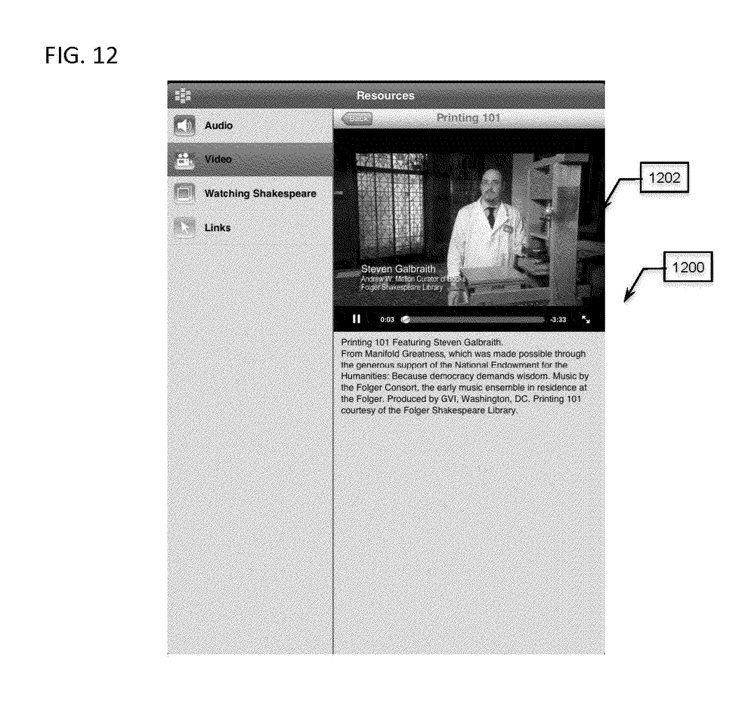

FIG. 12 illustrates a sample page 1200 that displays a video material 1202 in accordance with the framework 200. The video material 1202 may be dramatic interpretations of the primary text, lectures, expert commentary, user-created commentary, user-created interpretations of the primary text, and/or collaborative video materials created by two or more users.

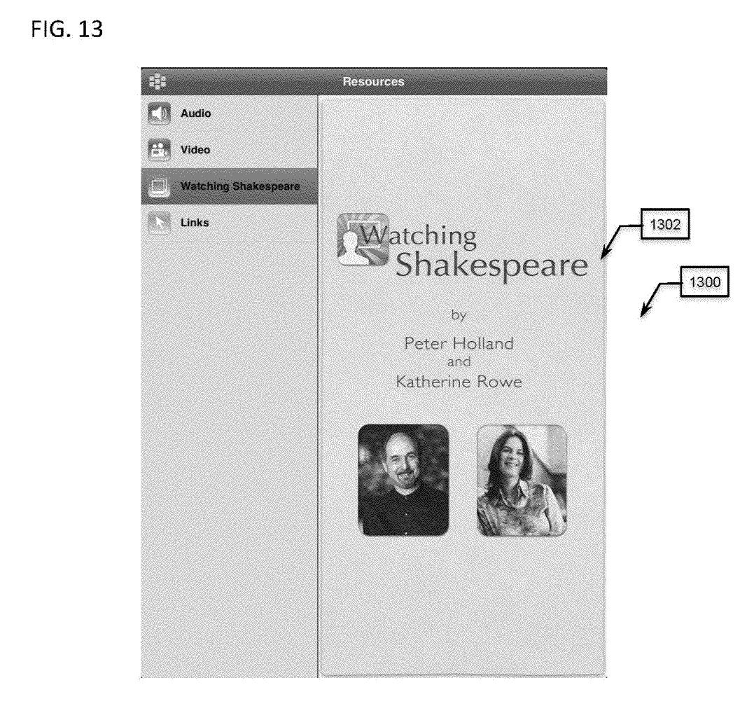

FIG. 13 illustrates an example page 1300, which provides a supplemental textual material 1302. As will be understood, the textual material 1302 may be expert commentary, reference materials, lecture notes, user-created commentary, user-created notes, user-created reports and/or collaborative textual materials created by two or more users, (e.g. a group conversation). Moreover, the framework 200 allows a user to use textual material 1302, video materials 1202, audio material 1102, and/or user notes 1004 to create the multimedia document 706.

FIG. 14 illustrates a sample page 1400 of the software platform that displays a plurality of experts 1408. As shown, the software platform provides information 1402 related to each expert including biographical and background information, and information about the supplemental materials provided by the expert. From example page 1400, a user may select an expert 1404 to be a member of the expert panel.

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents.

We claim:

1. A non-transient, computer readable media having stored thereon instructions for providing a user access to a supplemental material for a primary text, the instructions comprising:
causing a first textual record to be displayed on a user computing device;
storing in a data repository at least one of a plurality of audio files, a plurality of text files, or a plurality of video files associated with the first textual record;
storing in the data repository, a user submission of at least one of an audio file, text file, or video file, corresponding to the stored plurality of audio files, text files, and video files associated with the first textual record; and
in response to user selections, creating a multimedia document comprising at least two of, portions of the first textual record, portions of at least one audio file stored in the data repository, portions of at least one text file stored in the data repository, and portions of at least one video file stored in the data repository; and
displaying the multimedia document on the user computing device.

2. A computer-readable media as recited in claim 1, further comprising causing the created multimedia document to be stored in the data repository.

3. A computer-readable media as recited in claim 1, further comprising causing the created multimedia document to be transmitted to at least one additional user.

4. A computer-readable media as recited in claim 1, wherein the user-submitted file corresponds to the portion of the first textual record that is displayed on the computing device at the time the file is submitted, and wherein the data repository saves the identity of the portion of the first textual record along with the user-submitted file.

5. A computer-readable media as recited in claim 1, wherein the user specifies a first portion of the first textual record that the user-submitted file corresponds to, and the data repository saves the identity of the first portion of the first textual record along with the user-submitted file.

6. A non-transient, computer readable media having stored thereon instructions for providing a user access to a supplemental material for a primary text, the instructions comprising:
causing a first textual record to be displayed on a user computing device;
storing in a data repository at least two audio files corresponding to the first textual record;
in response to a first user selection, causing a first of at least two audio files to be played while the user computing device simultaneously displays the corresponding portion of the first textual record; and
in response to a second user selection, causing a second of at least two audio files to be played while the user computing device simultaneously displays the corresponding portion of the first textual record.

7. A computer-readable media as recited in claim 6, further comprising storing in a data repository a plurality of text files, and a plurality of video files associated with the first textual record.

8. A computer-readable media as recited in claim 6, further comprising saving a submitted file in the data repository in response to a user submission of at least one of the following, audio file, text file, or video file.

9. A computer-readable media as recited in claim 6, further comprising creating a multimedia document in response to user selections, comprising at least two of the following, portions of the first textual record, portions of at least one audio file stored in the data repository, portions of at least one text file stored in the data repository, and portions of at least one video file stored in the data repository.

10. A computer-implemented method of providing supplemental material for a primary text comprising:
viewing a first textual record on a user computing device;
upon a first user selection accessing an audio file corresponding to a first portion of the first textual record, while the user computing device simultaneously displays the first portion of the first textual record;
upon a second user selection accessing a textual file corresponding to a second portion of the first textual record, while the user computing device simultaneously displays the second portion of the first textual record; and
upon a third user selection accessing a video file corresponding to a third portion of the first textual record, while the user computing device simultaneously displays the third portion of the first textual record.

11. A computer-implemented method as recited in claim 10, further comprising, upon a fourth user selection, accessing audio file corresponding to a first portion of the first textual record, which is different from the first audio file.

12. A computer-implemented method as recited in claim 10, further comprising, creating a multimedia document comprising at least one of the following, portions of the first textual record, portions of at least one audio file, portions of at least one text file, and portions of at least one video file.

13. A computer-implemented method as recited in claim 10, further comprising, submitting a user-created file corresponding to a fourth portion of the first textual record, and saving the user-created file on the software platform.

14. A computer-implemented method as recited in claim 13, further comprising, sharing the multimedia document with other users.

15. A computer-implemented method as recited in claim 13, further comprising, sharing the multimedia document with other users via a social networking website.

16. A computer-implemented method as recited in claim 13, further comprising, creating a multimedia document comprising at two of the following, portions of the first textual record, portions of at least one audio file, portions of at least one text file, portions of at least one video file, and portions of at least one user-created file.

17. A computer-implemented method as recited in claim 16, further comprising, sharing the multimedia document with other users.

18. A computer-implemented method as recited in claim 17, further comprising, sharing the multimedia document with other users via a social networking website.

19. A system that provides for user interactive reading and learning, comprising:
a local component maintained on a computing device that provides for user interaction with source content, the local component including:
a user interface that enables a user to create user-generated content associated with the source content and customized source content, wherein the user interface enables the user to direct distribution of the user-generated content and the customized source content;
a local data store that maintains the source content, the user-generated content and the customized source content, and
a network interface component that communicates with at least one server;
a server component that communicates with the network interface and controls specification of a user group and distribution of the user-generated content and the customized source content to a member of the user group; and
a social media component that facilitates distribution of the user-generated content and the customized source content, such that the user interacts with the social media component via the user interface of the local component.

20. A method for providing a user with an interactive learning experience, comprising the steps of:
presenting source content to the user;
providing a user interface that enables the user to customize the source content, create user-generated content and direct distribution of the customized source content and user-generated content;
maintaining the customized source content and the user-generated content in a data store;
transmitting the user-generated content to a framework server that controls distribution of the user generated content based at least in part upon direction by the user via the user interface; and
distributing the user-generated content via social media based upon a defined user group and authorization.
